(19) United States
(12) Patent Application Publication
(10) Pub. No.: US 2026/0254303 A1
(43) Pub. Date: Aug. 27, 2026

(54) FRAMELESS MOTOR BASED ON POROUS HYDROGEL AND HEAT DISSIPATION METHOD THEREOF

(71) Applicants: ZHEJIANG UNIVERSITY, Hangzhou (CN); ZHEJIANG YINLUN THERMAL MANAGEMENT SYSTEMS OF NEW ENERGY CO., LTD., Taizhou (CN)

(72) Inventors: Yancheng WANG, Hangzhou (CN); Jinlei SHI, Hangzhou (CN); Qingming LI, Hangzhou (CN); Haonan ZHOU, Taizhou (CN); Dingge ZHANG, Taizhou (CN)

(73) Assignees: ZHEJIANG UNIVERSITY, Hangzhou (CN); ZHEJIANG YINLUN THERMAL MANAGEMENT SYSTEMS OF NEW ENERGY CO., LTD., Taizhou (CN)

(21) Appl. No.: 19/650,380

(22) Filed: Apr. 17, 2026

Related U.S. Application Data
(63) Continuation of application No. PCT/CN2025/081106, filed on Mar. 6, 2025.

(30) Foreign Application Priority Data
Dec. 27, 2024 (CN) 202411948811.4

(51) Int. Cl. H02K 3/24; H02K 1/14

(52) U.S. Cl. CPC H02K 3/24; H02K 1/146

(57) ABSTRACT

A frameless motor based on porous hydrogel and a heat dissipation method thereof are provided. Front and rear sealing shells are respectively mounted at front and rear ends of a motor stator. A motor rotor is provided inside the motor stator. The front sealing shell is fitted and embedded into one end of the motor stator to form a plurality of slots distributed axially, each of the slots is provided with the hot-end hydrogel. The rear sealing shell is embedded into the other end of the motor stator. The annular cold-end hydrogel is provided inside the rear sealing shell and adjacent to the rear end of the motor stator, and is in contact with the hot-end hydrogel. The inner and outer sides of the cold-end hydrogel are respectively provided with inner and outer graphene conductive tapes. Both hot-end and cold-end hydrogels are provided with cavities filled with the coolant.

### CROSS REFERENCE TO THE RELATED APPLICATIONS

This application is a continuation application of International Application No. PCT/CN2025/081106, filed on March 6, 2025, which is based upon and claims priority to Chinese Patent Application No. 202411948811.4, filed on December 27, 2024, the entire contents of which are incorporated herein by reference.

### TECHNICAL FIELD

The present invention relates to the technical field of frameless motors, and particularly to a frameless motor based on porous hydrogel and a heat dissipation method thereof.

### BACKGROUND

With the continuous development of embodied intelligence technology, humanoid robots, as the next-generation computing terminal after PCs, smartphones, and new energy vehicles, have become an important carrier of embodied intelligence technology due to their high flexibility and human-like movement patterns. The humanoid robots have shown great potential, especially in intelligent manufacturing, medical assistance, domestic services and others, and are gradually becoming a disruptive industry with broad market application prospects.

In the design of humanoid robots, a joint drive system is the core component for achieving flexible movement. Frameless motors, due to their high efficiency, compactness, and high integration, have become the preferred power source for driving the joint movement of humanoid robots. However, despite the many advantages of frameless motors, thermal management during operation remains a significant challenge, especially under high load and long-term operation scenarios, where heat loss has a significant impact on motor performance.

During the operation of a frameless motor, eddy current effects and Joule effects cause heat accumulation, leading to increase in temperatures of a stator and a rotor, thereby reducing the motor's output torque and power. Furthermore, the resistance of windings increases as temperature increases, further increasing Joule heat loss and significantly reducing the overall efficiency and energy utilization of the motor. Under long-term high-temperature operation, the insulation material of the windings gradually ages, increasing the risk of internal short circuits of the motor. The mechanical properties of the rotor and stator materials also deteriorate at high temperatures, weakening structural strength and making them prone to mechanical failures. Especially in applications of humanoid robot joints with high dynamic response, the motor is often in a state of frequently starting, stopping and accelerating, and this thermal fatigue effect may accelerate the aging process of the motor. Therefore, it is crucial to solve the heat loss problem of frameless motors.

Currently, among the heat dissipation solutions for frameless motors, air cooling for heat dissipation often significantly increases the overall size and weight of the motor due to the addition of fans, while liquid cooling for heat dissipation requires the design of multiple coolant circulation channels, which greatly increases the power consumption of the coolant pump and the system complexity when there are many motors in the drive system. Humanoid robots often have multiple joint modules, so the above methods are unfavorable for the application of frameless motors in humanoid robots. To maintain the stability of frameless motors during long-term operation, it is highly desirable to develop a compact, simple, efficient, and easily integrated heat dissipation solution to solve the heat loss problem.

### SUMMARY

To address the problems of severe heat loss, heavy thermal fatigue, and complex heat dissipation systems during operation of the frameless motor, the present invention aims to provide a frameless motor based on porous hydrogel and a heat dissipation method thereof. A porous hydrogel tightly adhered to the windings is prepared inside the motor via a simple method. The coolant circulates between the motor windings and the rear sealing shell through the action of capillary force of the porous hydrogel and the phase change principle of the coolant. Heat is then conducted to a cooling device through the graphene conductive tapes in the rear sealing shell, thereby achieving efficient heat dissipation.

The technical solution adopted by the present invention is as follows:

The present invention includes a front sealing shell, a hot-end hydrogel, a motor rotor, a motor stator, an inner graphene conductive tape, a cold-end hydrogel, an outer graphene conductive tape, and a rear sealing shell.

The front sealing shell and the rear sealing shell are respectively mounted at a front end and a rear end of the motor stator. The front sealing shell, the motor stator, and the rear sealing shell are all annular. The motor rotor is coaxially provided on an inner side of the motor stator. The front sealing shell is fitted and embedded into one end of the motor stator to form a plurality of slots distributed axially. Each of the slots is internally provided with the hot-end hydrogel. The rear sealing shell is fitted and embedded into the other end of the motor stator. An annular cold-end hydrogel is provided inside the rear sealing shell and adjacent to the rear end of the motor stator. The cold-end hydrogel is in contact with the hot-end hydrogel. An annular inner side and an annular outer side of the cold-end hydrogel are respectively provided with the inner graphene conductive tape and the outer graphene conductive tape.

Each hot-end hydrogel is provided with a cavity structure as a hot-end hydrogel inner cavity. The cold-end hydrogel is provided with a plurality of cavity structures, and each of the cavity structures serves as a cold-end hydrogel inner cavity. The hot-end hydrogel inner cavity and the cold-end hydrogel inner cavity are interconnected to form a heat dissipation cavity filled with coolant.

The motor stator includes a stator core and windings, where a plurality of stator slots are evenly distributed on an inner side of the stator core at intervals along a circumferential direction, the windings are wound on teeth between the stator slots of the stator core, a plurality of sealing inserts are evenly distributed on an inner side of the front sealing shell at intervals along the circumferential direction and point towards the rear sealing shell, and the sealing inserts are embedded into slot openings of the stator slots and seal the slot openings, so that slots for mounting the hot-end hydrogel are formed in the stator slots.

The cold-end hydrogel is provided with a cavity structure directly opposite to a cavity structure in each hot-end hydrogel to serve as the cold-end hydrogel inner cavity, and one cold-end hydrogel inner cavity and one hot-end hydrogel inner cavity are interconnected to form the heat dissipation cavity filled with the coolant.

An annular inner circumferential surface of the cold-end hydrogel is in tight contact with the inner graphene conductive tape. A front end face of the cold-end hydrogel is in tight contact with the hot-end hydrogel in the slots of the motor stator. An annular outer circumferential surface and a rear end face of the cold-end hydrogel are in tight contact with the outer graphene conductive tape. The inner graphene conductive tape, the cold-end hydrogel, and the outer graphene conductive tape are enclosed by the rear sealing shell and hermetically connected to a rear end face of the motor stator.

A side wall of the rear sealing shell is provided with an opening. The inner graphene conductive tape and the outer graphene conductive tape extend outward and merge through the opening, and an extended portion serves as a graphene conductive tape extended end and is adhered to an external heat sink.

The frameless motor is annular overall, and the motor rotor is connected to an output shaft in a direction pointing towards the front sealing shell or the rear sealing shell.

Each of the hot-end hydrogel and the cold-end hydrogel is the porous hydrogel, and the porous hydrogel is prepared using the following method:

S1: adding polyvinyl alcohol to water and stirring to obtain a hydrogel precursor.

S2: adding nano-copper particles to the hydrogel precursor, and inserting an ultrasonic disperser into the hydrogel precursor for vibration to obtain cured hydrogel as the porous hydrogel.

A mass ratio of the polyvinyl alcohol to the water is 1:(5-10).

The nano-copper particles have a particle size of 60 nm-100 nm, and a mass ratio of the nano-copper particles to the hydrogel precursor is 1:(7-9).

When the frameless motor is operating, a temperature of the motor stator rises, and the coolant in the hot-end hydrogel absorbs heat and vaporizes into hot steam, and the hot steam then enters the hot-end hydrogel inner cavity. Under the action of an internal air pressure, the hot steam flows from the hot-end hydrogel inner cavity to the cold-end hydrogel inner cavity. The cold-end hydrogel has a lower temperature, so that the hot steam condenses into condensate in the cold-end hydrogel inner cavity, releasing absorbed heat. The cold-end hydrogel absorbs the heat and transfers the heat to the external heat sink via the inner graphene conductive tape and the outer graphene conductive tape. The condensate, absorbed by the cold-end hydrogel, flows back from the cold-end hydrogel to the hot-end hydrogel under the action of a capillary force of the porous hydrogel, thus achieving heat dissipation through a continuous cycle.

The beneficial effects of the present invention are as follows:
1) A capillary structure tightly adhered to the heat source of the motor is manufactured through hydrogel. The heat generated in the motor mainly comes from the windings, which are composed of multiple coils wound together. The surfaces of the windings are uneven, resulting in irregular gaps between the windings. If capillary heat pipes are directly used to fill the gaps between the windings, it is impossible to achieve a tight adherence between the surface of the heat pipe and the coil. Furthermore, the external sealing material of the heat pipe has extra thermal resistance, significantly reducing heat dissipation efficiency. If capillary structures are directly manufactured between the windings, methods for manufacturing the capillary structure in the current industrial field mostly use copper powder sintering, which can damage the motor due to the high temperatures in a sintering process. Therefore, using hydrogel to manufacture the capillary structure between the windings achieves a tight adherence between the capillary structure and the windings while avoiding damage to the motor during manufacturing.
2) Porous hydrogel has high thermal conductivity, and a preparation method thereof is simple. Currently, the most widely used method for manufacturing the porous hydrogel typically involves placing the hydrogel in a vacuum device and using negative pressure to extract air bubbles in the gels in a curing process to create internal pores. This method, with slow curing speed and cumbersome steps, also makes it difficult to manufacture cavities for gas flow within the porous hydrogel. The ultrasonic vibration copper particle method proposed in the present invention enables rapid fabrication of micropores. Moreover, the heat generated by ultrasonic vibration accelerates the evaporation of water in the hydrogel, increasing the curing speed. Furthermore, the abundant distribution of nano-copper particles within the porous hydrogel improves the thermal conductivity of the porous hydrogel.
3) The heat dissipation solution proposed in the present invention has a simple structure, facilitating manufacturing and integration. When multiple motors in a drive system require heat dissipation, air cooling for heat dissipation often increases the overall size and weight due to the addition of fans, while liquid cooling for heat dissipation requires the design of multiple coolant circulation channels, increasing the power consumption of the pump and the system complexity. These methods are unfavorable for the application of frameless motors in humanoid robots. The heat dissipation solution of the present invention uses graphene conductive tapes to conduct heat from the motor. In a system with multiple motors, the graphene conductive tapes are simply connected to the same heat sink to achieve simultaneous cooling of multiple motors, resulting in a simple, reliable system with high heat dissipation performance.

### BRIEF DESCRIPTION OF THE DRAWINGS

FIG. 1 is an overall isometric view of the present invention.

FIG. 2 is a three-dimensional exploded view of the present invention.

FIG. 3 is a cross-sectional view of a motor stator of the present invention.

FIG. 4 is an assembly diagram of a front sealing cover and a motor stator core of the present invention.

FIG. 5 is a cross-sectional view of a rear end cover of the present invention.

FIG. 6 is a schematic diagram of the heat dissipation principle of the porous hydrogel of the present invention.

FIG. 7 is a schematic diagram showing the preparation steps of the hot-end hydrogel of the present invention.

FIG. 8 is a schematic diagram showing the correspondence between the hot-end hydrogel cavity and the cold-end hydrogel cavity of the present invention.

In the figures: 1, graphene conductive tape extended end; 2, front sealing shell; 3, hot-end hydrogel; 4, motor rotor; 5, motor stator; 6, inner graphene conductive tape; 7, cold-end hydrogel; 8, outer graphene conductive tape; 9, rear sealing shell; 10, stator core; 11, winding; 12, hot-end hydrogel inner cavity; 13, sealing insert; and 14, cold-end hydrogel inner cavity.

### DETAILED DESCRIPTION OF THE EMBODIMENTS

The present invention will be further described below with reference to the drawings and embodiments.

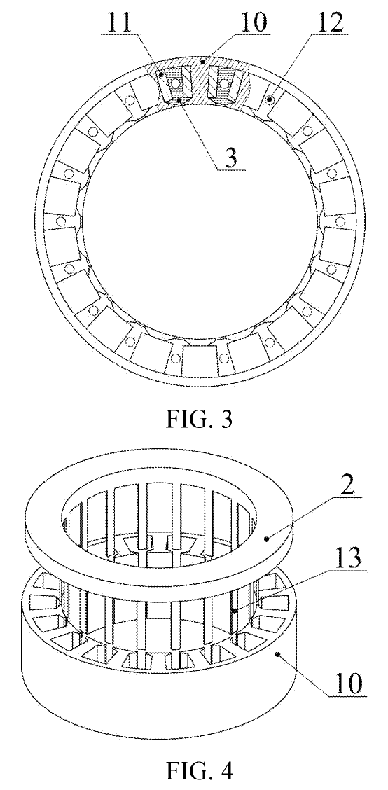

The frameless motor based on porous hydrogel, as shown in FIGS. 2-3, includes the front sealing shell 2, the hot-end hydrogel 3, the motor rotor 4, the motor stator 5, the inner graphene conductive tape 6, the cold-end hydrogel 7, the outer graphene conductive tape 8, and the rear sealing shell 9.

The front sealing shell 2 and the rear sealing shell 9 are respectively mounted at the front end and the rear end of the motor stator 5. The front sealing shell 2, the motor stator 5, and the rear sealing shell 9 are all annular. The front sealing shell, the motor stator, and the rear sealing shell form a sealed chamber, which is sealed with sealant. The chamber is filled with porous hydrogel and coolant. The motor rotor 4 is coaxially provided on the inner side of the motor stator 5. The front sealing shell 2 is fitted and embedded into one end of the motor stator 5 to form a plurality of slots distributed axially. Each of the slots is internally provided with the hot-end hydrogel 3. The rear sealing shell 9 is fitted and embedded into the other end of the motor stator 5. The annular cold-end hydrogel 7 is provided inside the rear sealing shell 9 and adjacent to the rear end of the motor stator 5. The cold-end hydrogel 7 is in contact with all the hot-end hydrogels 3 in the slots of the motor stator 5. The annular inner side and the annular outer side of the cold-end hydrogel 7 are respectively provided with the inner graphene conductive tape 6 and the outer graphene conductive tape 8.

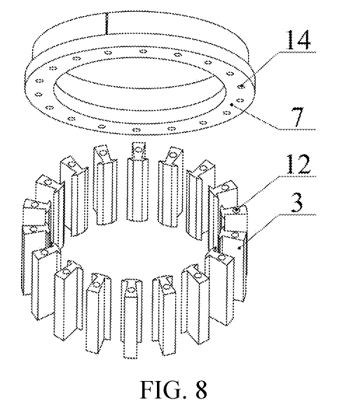

As shown in FIG. 8, each hot-end hydrogel 3 is provided with a cavity structure as a hot-end hydrogel inner cavity 12. The cold-end hydrogel 7 is provided with a plurality of cavity structures, and each of the cavity structures serves as the cold-end hydrogel inner cavity 14. The hot-end hydrogel inner cavity 12 and the cold-end hydrogel inner cavity are interconnected in correspondence to form a heat dissipation cavity, which is sealed and filled with coolant.

As shown in FIGS. 3-4, the motor stator 5 includes the stator core 10 and the windings 11. A plurality of stator slots are evenly distributed on the inner side of the stator core 10 at intervals along the circumferential direction. The windings 11 are wound on the teeth between the stator slots of the stator core 10. A plurality of sealing inserts 13 are evenly distributed on the inner side of the front sealing shell 2 at intervals along the circumferential direction and point towards the rear sealing shell 9. The sealing inserts 13 are embedded into the slot openings of the stator slots and seal the slot openings, so that slots for mounting the hot-end hydrogel 3 and the windings 11 are formed in the stator slots.

The cold-end hydrogel 7 is provided with a cavity structure directly opposite to the cavity structure in each hot-end hydrogel 3 to serve as the cold-end hydrogel inner cavity 14. One cold-end hydrogel inner cavity 14 and one hot-end hydrogel inner cavity 12 are interconnected in correspondence to form the heat dissipation cavity, which is sealed and filled with coolant.

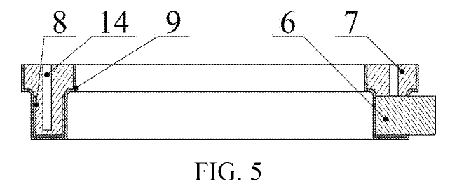

As shown in FIG. 5, the annular inner circumferential surface of the cold-end hydrogel 7 is in tight contact with the inner graphene conductive tape 6. The front end face of the cold-end hydrogel 7 is in tight contact with the hot-end hydrogel 3 in the slots of the motor stator 5. The annular outer circumferential surface and the rear end face of the cold-end hydrogel 7 are in tight contact with the outer graphene conductive tape 8. The inner graphene conductive tape 6, the cold-end hydrogel 7, and the outer graphene conductive tape 8 are enclosed by the rear sealing shell 9 and hermetically connected to the rear end face of the motor stator 5.

A side wall of the rear sealing shell 9 is provided with an opening. The inner graphene conductive tape 6 and the outer graphene conductive tape 8 extend outward and merge through the opening. The extended portion serves as the graphene conductive tape extended end 1 and is adhered to an external heat sink.

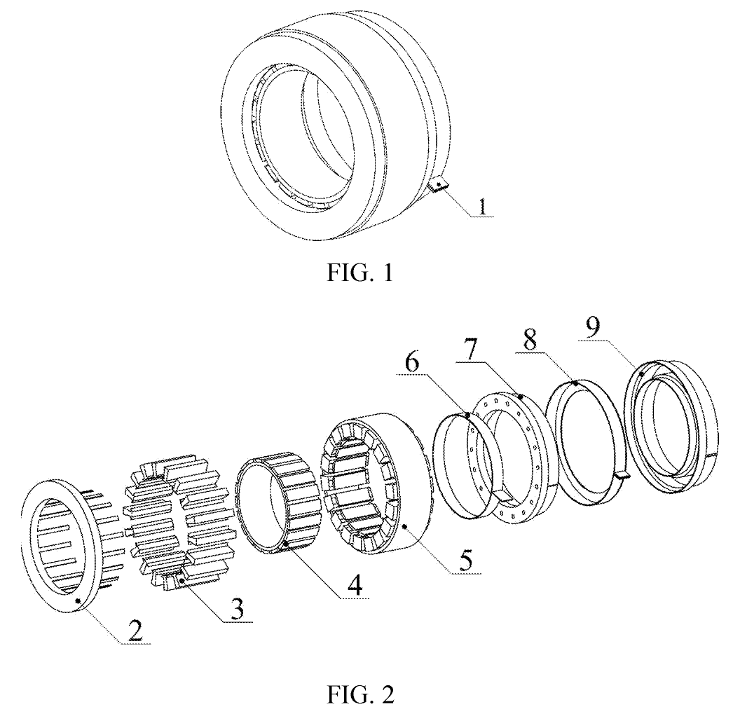

As shown in FIG. 1, the frameless motor is annular overall. The motor rotor 4 is connected to an output shaft in the direction pointing towards the front sealing shell 2 or the rear sealing shell 9. The heat dissipation solution is integrated inside the motor, eliminating the need for the additional shell.

Each of the hot-end hydrogel 3 and the cold-end hydrogel 7 is porous hydrogel, and the porous hydrogel is prepared using the following method:

S1: polyvinyl alcohol is added to water and stirred to obtain a hydrogel precursor; and

S2: nano-copper particles are added to the hydrogel precursor, and a column-type ultrasonic disperser is inserted into the hydrogel precursor and vertically fixed at the midpoint between every two windings for vibration to obtain cured hydrogel as the porous hydrogel.

The ultrasonic disperser emits sound waves to generate a cavitation effect that causes the nano-copper particles to vibrate at high frequency, thus forming numerous pores in a hydrogel curing process. Simultaneously, the cavitation effect generates heat during ultrasonic dispersion, accelerating the evaporation of water in the hydrogel and thus speeding up the curing process of the hydrogel. The abundant distribution of nano-copper particles improves the thermal conductivity of the hydrogel.

The hydrogel precursor is the hydrogel presented in a liquid state.

A mass ratio of the polyvinyl alcohol to the water is 1:(5-10).

The nano-copper particles have a particle size of 60 nm-100 nm, and a mass ratio of the nano-copper particles to the hydrogel precursor is 1:(7-9).

Each of the hot-end hydrogel 3 and the cold-end hydrogel 7 is the porous hydrogel. The hot-end hydrogel 3 is named because the hot-end hydrogel 3 is in contact with the windings 11 and heated. The cold-end hydrogel 7 is named because the cold-end hydrogel 7 has a lower temperature and is cooled by adhering to the external heat sink through the inner graphene conductive tape 6 and the outer graphene conductive tape 8.

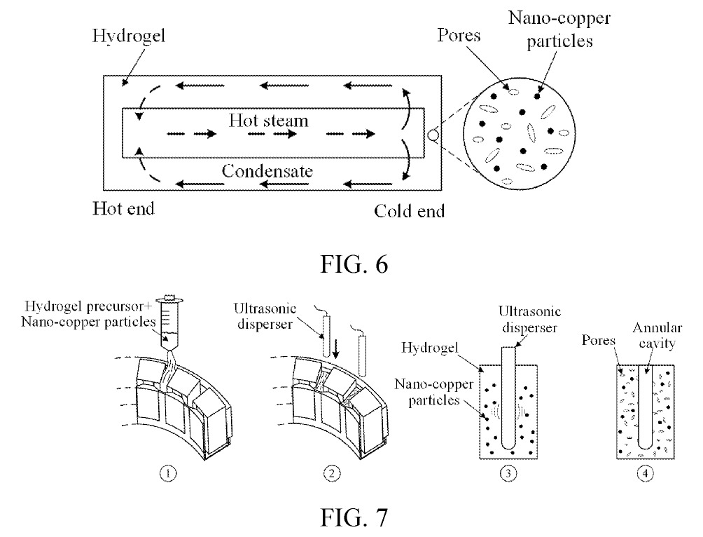

As shown in FIG. 6, when the frameless motor is operating, the coolant inside the cavity of the hot-end hydrogel 3 is heated and circulates within the hot-end hydrogel 3, the cold-end hydrogel 7 and the heat dissipation cavity, thereby achieving efficient heat dissipation for the motor.

Specifically, when the frameless motor is operating, the temperature of the motor stator 5 rises. The coolant in the hot-end hydrogel 3 absorbs heat and vaporizes into hot steam, and the hot steam then enters the hot-end hydrogel inner cavity 12. Under the action of an internal air pressure, the hot steam flows from the hot-end hydrogel inner cavity 12 to the cold-end hydrogel inner cavity 14. Because the cold-end hydrogel 7 has a lower temperature, the hot steam condenses into condensate in the cold-end hydrogel inner cavity 14, releasing the absorbed heat. The cold-end hydrogel 7 absorbs the heat and transfers the heat to the external heat sink via the inner graphene conductive tape 6 and the outer graphene conductive tape 8. The condensate, absorbed by the cold-end hydrogel 7, flows back from the cold-end hydrogel 7 to the hot-end hydrogel 3 under the action of capillary force of the porous hydrogel, thus achieving efficient heat dissipation through this continuous cycle.

The coolant circulates between the motor windings and the rear sealing shell through the action of capillary force of the porous hydrogel and the phase change principle of the coolant. Heat is then conducted to a cooling device through the graphene conductive tapes in the rear sealing shell, thereby achieving efficient heat dissipation. The heat conducting process of the heat dissipation solution is as follows: the hot end, i.e., the motor stator, transfers the heat to the coolant within the hydrogel, then the coolant transfers the heat to the cold end, i.e., the rear sealing shell, through the phase change cycle, and next, the inner graphene conductive tape and the outer graphene conductive tape of the rear sealing shell transfer the heat to the external heat sink. Specifically, the rear sealing shell is connected to the external heat sink via the graphene conductive tapes, and thus has the lower temperature than that of the motor stator, so that the temperature difference drives the phase change cycle of the coolant.

The manufacturing process of the frameless motor includes the following steps, as shown in FIG. 7:

S1: the front sealing shell 2 is fitted and embedded into the motor stator 5 to form the plurality of slots distributed axially.

S2: the hydrogel precursor doped with the nano-copper particles is injected into each of the slots using an injector. Due to the liquid fluidity of the hydrogel precursor, after standing for a period of time, the hydrogel precursor can be tightly adhered to the irregular surface of the windings 11 on the motor stator 5. Subsequently, the column-type ultrasonic disperser is inserted into the hydrogel precursor in each of the slots. All column-type ultrasonic dispersers vibrate simultaneously. The cavitation effect generated by the ultrasound causes the nano-copper particles to vibrate at high frequency, thus forming numerous pores in a hydrogel curing process. After the hydrogel precursor is cured, the vibration is stopped, and the column-type ultrasonic dispersers are removed. The original location of the column-type ultrasonic disperser forms the hot-end hydrogel inner cavity 12, and the hot-end hydrogel 3 with the hot-end hydrogel inner cavity 12, the front sealing shell 2 filled with the hot-end hydrogel 3, and the motor stator 5 are obtained.

S3: the rear sealing shell 9, the inner graphene conductive tape 6, and the outer graphene conductive tape 8 are assembled to form the annular cavity.

S4: the hydrogel precursor doped with the nano-copper particles is injected into the annular cavity using the injector. The plurality of column-type ultrasonic dispersers are then inserted into the hydrogel precursor within the annular cavity. All column-type ultrasonic dispersers vibrate simultaneously. After the hydrogel precursor is cured, the vibration is stopped, and the column-type ultrasonic dispersers are removed. The original location of the column-type ultrasonic disperser forms the cold-end hydrogel inner cavity 14, and the cold-end hydrogel 7 with the cold-end hydrogel inner cavity 14 and the rear sealing shell 9 filled with the cold-end hydrogel 7 are obtained.

The number of column-type ultrasonic dispersers depends on the number of motor windings.

S5: an appropriate amount of coolant is added to both the hot-end hydrogel inner cavity 12 of the hot-end hydrogel 3 and the cold-end hydrogel inner cavity 14 of the cold-end hydrogel 7. The coolant is absorbed by the hot-end hydrogel 3 and the cold-end hydrogel 7.

S6: the front sealing shell 2 filled with the hot-end hydrogel 3, the motor stator 5, the motor rotor 4, and the rear sealing shell 9 filled with the cold-end hydrogel 7 are sequentially assembled to obtain the frameless motor.

The windings are formed by winding a plurality of turns of wires, with the uneven surface and tiny gaps between the wires. Due to the liquid fluidity of the hydrogel precursor, the hydrogel precursor can be tightly adhered to the irregular surface of the windings 11.

S4 specifically includes: the hydrogel precursor doped with the nano-copper particles is injected into the annular cavity using the injector. Then, the column-type ultrasonic disperser is inserted into the hydrogel precursor of the annular cavity at the position corresponding to each hot-end hydrogel inner cavity 12. All column-type ultrasonic dispersers vibrate simultaneously. After the hydrogel precursor is cured, the vibration is stopped, and the column-type ultrasonic dispersers are removed, obtaining the cold-end hydrogel 7 with the cold-end hydrogel inner cavity 14. The distribution positions of the column-type ultrasonic dispersers are the same as those in the preparation of the hot-end hydrogel, ensuring that the hot-end hydrogel inner cavity 12 and the cold-end hydrogel inner cavity 14 are interconnected in pairs after preparation.

The precursor of the hot-end hydrogel fills the spaces between the motor windings. In a hydrogel curing process, the nano-copper particles therein are vibrated at high frequency, forming numerous pores and achieving the preparation of the porous hydrogel tightly adhered to the windings.

The frameless motor employing the heat dissipation solution of the present invention is compact and suitable for a drive system with a plurality of motors operating simultaneously. The graphene conductive tape extended end 1 of each motor is simply connected to the external heat sink to achieve synchronous and efficient cooling for the plurality of motors. Other heat dissipation methods using air cooling and liquid cooling result in additional volume, higher power consumption, and system complexity, which is disadvantageous for humanoid robot applications.

The above specific embodiments are used to explain and illustrate the present invention, not to limit the present invention. Equivalent variations and modifications made within the spirit of the present invention and the protection scope of the claims, i.e., based on the protection scope of the present invention and the content of the specification, shall fall within the protection scope of the present invention.

What is claimed is:

1. A frameless motor based on porous hydrogel, comprising a front sealing shell, a hot-end hydrogel, a motor rotor, a motor stator, an inner graphene conductive tape, a cold-end hydrogel, an outer graphene conductive tape, and a rear sealing shell;
the front sealing shell and the rear sealing shell are respectively mounted at a front end and a rear end of the motor stator; the front sealing shell, the motor stator, and the rear sealing shell are all annular; the motor rotor is coaxially provided on an inner side of the motor stator; the front sealing shell is fitted and embedded into a first end of the motor stator to form a plurality of slots distributed axially; each of the plurality of slots is internally provided with the hot-end hydrogel; the rear sealing shell is fitted and embedded into a second end of the motor stator; an annular cold-end hydrogel is provided inside the rear sealing shell and adjacent to the rear end of the motor stator; the cold-end hydrogel is in contact with the hot-end hydrogel; and an annular inner side and an annular outer side of the cold-end hydrogel are respectively provided with the inner graphene conductive tape and the outer graphene conductive tape; and
each hot-end hydrogel is provided with a first cavity structure as a hot-end hydrogel inner cavity; the cold-end hydrogel is provided with a plurality of cavity structures, and each of the plurality of cavity structures serves as a cold-end hydrogel inner cavity; and the hot-end hydrogel inner cavity and the cold-end hydrogel inner cavity are interconnected to form a heat dissipation cavity filled with coolant.

2. The frameless motor based on the porous hydrogel according to claim 1, wherein the motor stator comprises a stator core and windings, wherein a plurality of stator slots are evenly distributed on an inner side of the stator core at intervals along a circumferential direction, the windings are wound on teeth between the plurality of stator slots of the stator core, a plurality of sealing inserts are evenly distributed on an inner side of the front sealing shell at intervals along the circumferential direction and point towards the rear sealing shell, and the plurality of sealing inserts are embedded into slot openings of the plurality of stator slots and seal the slot openings, so that slots for mounting the hot-end hydrogel are formed in the plurality of stator slots.

3. The frameless motor based on the porous hydrogel according to claim 2, wherein the cold-end hydrogel is provided with a second cavity structure directly opposite to the first cavity structure in each hot-end hydrogel to serve as the cold-end hydrogel inner cavity, and one cold-end hydrogel inner cavity and one hot-end hydrogel inner cavity are interconnected to form the heat dissipation cavity filled with the coolant.

4. The frameless motor based on the porous hydrogel according to claim 1, wherein an annular inner circumferential surface of the cold-end hydrogel is in contact with the inner graphene conductive tape; a front end face of the cold-end hydrogel is in contact with the hot-end hydrogel in the plurality of slots of the motor stator; an annular outer circumferential surface and a rear end face of the cold-end hydrogel are in contact with the outer graphene conductive tape; and the inner graphene conductive tape, the cold-end hydrogel, and the outer graphene conductive tape are enclosed by the rear sealing shell and hermetically connected to a rear end face of the motor stator.

5. The frameless motor based on the porous hydrogel according to claim 1, wherein a side wall of the rear sealing shell is provided with an opening; the inner graphene conductive tape and the outer graphene conductive tape extend outward and merge through the opening, and an extended portion serves as a graphene conductive tape extended end and is adhered to an external heat sink.

6. The frameless motor based on the porous hydrogel according to claim 1, wherein the frameless motor is annular in overall, and the motor rotor is connected to an output shaft in a direction pointing towards the front sealing shell or the rear sealing shell.

7. The frameless motor based on the porous hydrogel according to claim 1, wherein each of the hot-end hydrogel and the cold-end hydrogel is the porous hydrogel, and the porous hydrogel is prepared using the following method:
S1: adding polyvinyl alcohol to water and stirring to obtain a hydrogel precursor; and
S2: adding nano-copper particles to the hydrogel precursor, and inserting an ultrasonic disperser into the hydrogel precursor for vibration to obtain cured hydrogel as the porous hydrogel.

8. The frameless motor based on the porous hydrogel according to claim 7, wherein a mass ratio of the polyvinyl alcohol to the water is 1:(5-10).

9. The frameless motor based on the porous hydrogel according to claim 7, wherein the nano-copper particles have a particle size of 60 nm-100 nm, and a mass ratio of the nano-copper particles to the hydrogel precursor is 1:(7-9).

10. A heat dissipation method applied to the frameless motor according to claim 1, wherein
when the frameless motor is operating, a temperature of the motor stator rises, the coolant in the hot-end hydrogel absorbs heat and vaporizes into hot steam, and the hot steam then enters the hot-end hydrogel inner cavity; under an action of an internal air pressure, the hot steam flows from the hot-end hydrogel inner cavity to the cold-end hydrogel inner cavity; the cold-end hydrogel has a lower temperature, so that the hot steam condenses into condensate in the cold-end hydrogel inner cavity, releasing absorbed heat; the cold-end hydrogel absorbs the absorbed heat and transfers the absorbed heat to an external heat sink via the inner graphene conductive tape and the outer graphene conductive tape; and the condensate, absorbed by the cold-end hydrogel, flows back from the cold-end hydrogel to the hot-end hydrogel under an action of a capillary force of the porous hydrogel, thus achieving heat dissipation through a continuous cycle.

11. The heat dissipation method according to claim 10, wherein in the frameless motor, the motor stator comprises a stator core and windings, wherein a plurality of stator slots are evenly distributed on an inner side of the stator core at intervals along a circumferential direction, the windings are wound on teeth between the plurality of stator slots of the stator core, a plurality of sealing inserts are evenly distributed on an inner side of the front sealing shell at intervals along the circumferential direction and point towards the rear sealing shell, and the plurality of sealing inserts are embedded into slot openings of the plurality of stator slots and seal the slot openings, so that slots for mounting the hot-end hydrogel are formed in the plurality of stator slots.

12. The heat dissipation method according to claim 11, wherein in the frameless motor, the cold-end hydrogel is provided with a second cavity structure directly opposite to the first cavity structure in each hot-end hydrogel to serve as the cold-end hydrogel inner cavity, and one cold-end hydrogel inner cavity and one hot-end hydrogel inner cavity are interconnected to form the heat dissipation cavity filled with the coolant.

13. The heat dissipation method according to claim 10, wherein in the frameless motor, an annular inner circumferential surface of the cold-end hydrogel is in contact with the inner graphene conductive tape; a front end face of the cold-end hydrogel is in contact with the hot-end hydrogel in the plurality of slots of the motor stator; an annular outer circumferential surface and a rear end face of the cold-end hydrogel are in contact with the outer graphene conductive tape; and the inner graphene conductive tape, the cold-end hydrogel, and the outer graphene conductive tape are enclosed by the rear sealing shell and hermetically connected to a rear end face of the motor stator.

14. The heat dissipation method according to claim 10, wherein in the frameless motor, a side wall of the rear sealing shell is provided with an opening; the inner graphene conductive tape and the outer graphene conductive tape extend outward and merge through the opening, and an extended portion serves as a graphene conductive tape extended end and is adhered to the external heat sink.

15. The heat dissipation method according to claim 10, wherein in the frameless motor, the frameless motor is annular in overall, and the motor rotor is connected to an output shaft in a direction pointing towards the front sealing shell or the rear sealing shell.

16. The heat dissipation method according to claim 10, wherein in the frameless motor, each of the hot-end hydrogel and the cold-end hydrogel is the porous hydrogel, and the porous hydrogel is prepared using the following method:
S1: adding polyvinyl alcohol to water and stirring to obtain a hydrogel precursor; and
S2: adding nano-copper particles to the hydrogel precursor, and inserting an ultrasonic disperser into the hydrogel precursor for vibration to obtain cured hydrogel as the porous hydrogel.

17. The heat dissipation method according to claim 16, wherein in the frameless motor, a mass ratio of the polyvinyl alcohol to the water is 1:(5-10).

18. The heat dissipation method according to claim 16, wherein in the frameless motor, the nano-copper particles have a particle size of 60 nm-100 nm, and a mass ratio of the nano-copper particles to the hydrogel precursor is 1:(7-9).
